(19) United States
(12) Patent Application Publication
(10) Pub. No.: US 2013/0326010 A1
(43) Pub. Date: Dec. 5, 2013

(54) SYSTEM AND METHOD FOR MONITORING NETWORK CONNECTIONS

(71) Applicant: Novatium Solutions Pvt Ltd, Chennai (IN)

(72) Inventors: Alok Singh, Chennai (IN); G. Vinod Kumar, Chennai (IN); S. Badrinath, Chennai (IN)

(73) Assignee: Novatium Solutions Pvt Ltd, Chennai (IN)

(21) Appl. No.: 13/683,104

(22) Filed: Nov. 21, 2012

(30) Foreign Application Priority Data
Mar. 21, 2012 (IN) 1036/CHE/2012

(51) Int. Cl. H04L 12/26

(52) U.S. Cl. CPC H04L 43/06
USPC 709/217; 709/224

(57) ABSTRACT

System and method for monitoring network connection are provided. The system includes at least one client device configured for providing a user access to a public network via a network connection and a network monitoring module coupled to the client device, the network monitoring module configured for monitoring the network connection based on an establishment of a transmission control protocol connection between the client device and the public network. The method includes steps of monitoring establishment of a transmission control protocol connection between a client device and a worldwide web server and generating network monitoring statistics on availability of network connection based on the information derived from monitoring.

### REFERENCE TO RELATED APPLICATIONS

This application claims priority from an Indian patent application No. 1036/CHE/2012 filed on 21 Mar. 2012, which is hereby incorporated herein in its entirety.

### FIELD OF INVENTION

The invention generally relates to computer networks and more particularly to monitoring network conditions.

### BACKGROUND OF THE INVENTION

A client device is typically connected to the internet through a broadband DSL or cable modem or mobile broadband connection provided by a local Internet Service Provider (ISP). To access the internet and also to reach a server unit, the availability and reliability of the internet connection, provided by the ISP, is important. One of the network monitoring tools suggested in the prior art includes connectivity monitoring mechanisms.

One of the main disadvantages of Internet Service Provider Connectivity Monitoring Mechanisms (ISP-CMM) suggested in the prior art is the significant amount of extra traffic it introduces into a network. The network may connect a plurality of client devices to a server unit. Each of the client devices may run one or more utility applications to periodically check the internet connectivity of every user. This results in a significant amount of extra byte consumption by the user of the client device and hence the user's average monthly internet billing cost may increase significantly due to this. In addition, since the server unit has to run ISP-CMM instances for every user connected to the client device, a lot of processing overhead is generated at the server unit, apart from the increased network bandwidth requirement for this purpose. The server units also typically maintain a log of these measurements and hence this requires a large amount of storage space and maintenance at their end.

Another disadvantage of network monitoring tools suggested in the prior art is that they are run occasionally and seldom on a regular basis. First, during installation of client device and second, during times when there are internet connectivity problems. Due to this, one is unable to find out the overall quality of the internet connection provided by the ISP, as enough monitoring data is not available.

Special utility applications for monitoring network health run between the client device and the server unit, to constantly monitor the internet connectivity of the user. Such utilities generate significant amount of overhead traffic and hence add to the overall network traffic of each of the users of the client device and the server unit. They also increase the internet usage bill of the users of the client device. The same also applies to end computers (Personal Computers (PCs) and other desktops connecting to the internet using an ISP.

Also in client devices, ISP-CMMs may be run at predetermined times, considering the significant amount of traffic overhead introduced by these tools. Hence the availability level of internet connectivity estimated by such measurements may not be accurate (when compared to an average value of the samples taken at different intervals in a day). The availability and quality of ISPs' internet connectivity generally varies significantly at different times of the day. For example, during peak business hours, the quality may be low due to network congestion, whereas during off-peak times/nights, the quality may be good due to fewer users using the ISP's network. Hence, a good estimate of the quality of the ISP's connection should be arrived at based not only on frequency of measurements but also by monitoring the actual failure/success percentage of internet connectivity attempts made by a user.

Another problem frequently encountered by ISPs and client device managers is due to lack of knowledge of internet operating mechanisms by end users. There are many cases where users call the ISPs when they are unable to access certain web sites, thinking that the problem is with the ISPs connection, when the actual problem is due to the web servers being down temporarily or due to the web sites no longer existing. A majority of the network monitoring mechanisms in the prior art check connectivity to a few popular web sites and decide on their internet connectivity status assuming that these popular sites would always be functionally up.

Yet another problem is that client devices and other computers rarely have self-monitoring mechanisms for detecting connectivity problems and overall statistics about the availability and quality of their internet connectivity. Instead, they rely on external monitoring tools run from server units or on ISP technicians visiting onsite.

Some data link layer protocols like PPP (Point-to-Point Protocol) may have their own keep-alive mechanisms to periodically check their connectivity with the PPP server at the ISP. But the problem with relying on protocols like PPP is that the client device may or may not be running them. Such protocols may be run on a modem, providing connectivity to the client device. Hence, network monitoring tools cannot rely on such methods to check ISP connectivity.

Hence, there exists a need for a system and method to monitor network connectivity that does not increase network traffic, does not adversely affect internet usage billing of the user, demands low bandwidth requirement and requires less storage space for storing network monitoring-related data. In short, there exists a need for a passive method of monitoring network connectivity.

### BRIEF DESCRIPTION OF THE INVENTION

The above-mentioned shortcomings, disadvantages and problems are addressed herein which will be understood by reading and understanding the following specification.

In one embodiment a system for monitoring network connection is provided. The system comprises at least one client device configured for providing a user access to a public network via a network connection and a network monitoring module coupled to the client device, the network monitoring module configured for monitoring the network connection based on an establishment of a transmission control protocol connection between the client device and the public network.

In another embodiment, a method of monitoring network connection is provided. The method comprises steps of monitoring establishment of a transmission control protocol connection between a client device and a worldwide web server and generating network monitoring statistics on availability of network connection based on information derived from monitoring.

In yet another embodiment a method of monitoring network connection comprises steps of installing a network monitoring module in a client device, the network monitoring module configured for monitoring an inflow of one or more internet protocol packets, receiving an internet protocol packet from a worldwide web server, updating network monitoring statistics upon successful establishment of the connection in response to receiving the internet packet and recording a time stamp indicating the time of successful establishment of the connection.

Systems and methods of varying scope are described herein. In addition to the aspects and advantages described in this summary, further aspects and advantages will become apparent by reference to the drawings and with reference to the detailed description that follows.

### BRIEF DESCRIPTION OF THE DRAWINGS

FIG. 1 shows a block diagram of a system for monitoring network connection as described in one embodiment;

FIG. 2 shows a block diagram of a system for monitoring network connection as described in another embodiment;

FIG. 3 shows a flow diagram depicting a method of monitoring network connection as described in one embodiment; and

FIG. 4 shows a flow diagram depicting a method of monitoring network connection as described in another embodiment.

### DETAILED DESCRIPTION OF THE INVENTION

In the following detailed description, reference is made to the accompanying drawings that form a part hereof, and in which is shown by way of illustration specific embodiments, which may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken in a limiting sense.

One or more of the problems of the conventional prior art may be overcome by various embodiments of the present invention. The present invention relates to a system and method of monitoring the availability of ISP connectivity at a client device by passively watching the internet usage of the user of the client device.

Users of a Cloud Computing Environment (CCE) access some of their computing requirements dynamically. The computing requirements are not necessarily locally resident but are usually accessed across a network. The user uses a resource for a required time and releases the resource on completion. Thus the available resources are shared between a set of users. Thus resource optimization and hence cost optimization is achieved for all the customers and the different players in the client device.

To realize the above mentioned objectives, utility computing utilizes a number of components that provide computing to users, manage the usage and features requested by the users and monitor and manage different physical components in the environment. These components are spread over the three physical components in the environment, namely, a client device at the user's end (may also be referred to as a computing device), a server unit and a network that connects these two components.

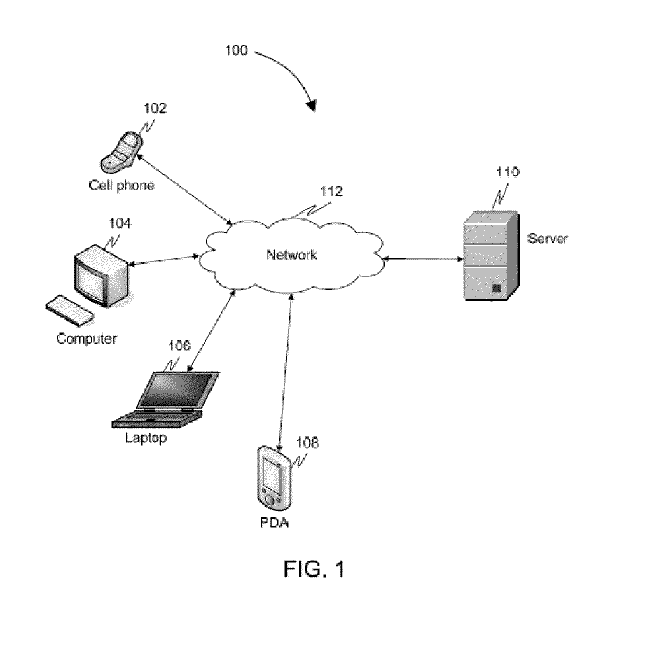

Accordingly, in one embodiment, as shown in FIG. 1, a system for monitoring network connection is provided. The system comprises at least one client device configured for providing a user, access to a public network via a network connection and a server unit coupled to each of the client devices via the public network.

The client device is a simple to use and typically low power consuming device that is capable of running local and remote applications. The client device connects to the server unit to access the native Operating System (OS) applications required by a user of the client device. These applications are referred to as remote applications (RAPPs). Local Applications (LAPPs) include, among other things, a browser through which the user can access the internet directly without connecting to the server unit. The features in the client device are configurable and are dynamically managed by the server unit. The server unit consists of two components. One component provides the features and functionality required by the users. The other component manages the networked environment.

The network includes the physical network and the protocols that the client device and the server unit use to communicate with each other. Accordingly, the public network is one of a wired and a wireless network and comprises one or more public network protocols. The public networks include Internet, Intranet, LAN, WAN or such type of TCP/IP networks for communicating data or signals between two points.

The client device includes a communication device capable of accessing the public network. Further, the client device is a portable or a non-portable device configured for personal or general use. Typically, the client device (as shown in FIG. 1) may comprise a cellular phone 102, a desktop computer 104 (including a network computer), a notebook, tablet or a laptop 106 and a Personal Digital Assistant (PDA) 108 that is capable of communicating with one or more of the external devices.

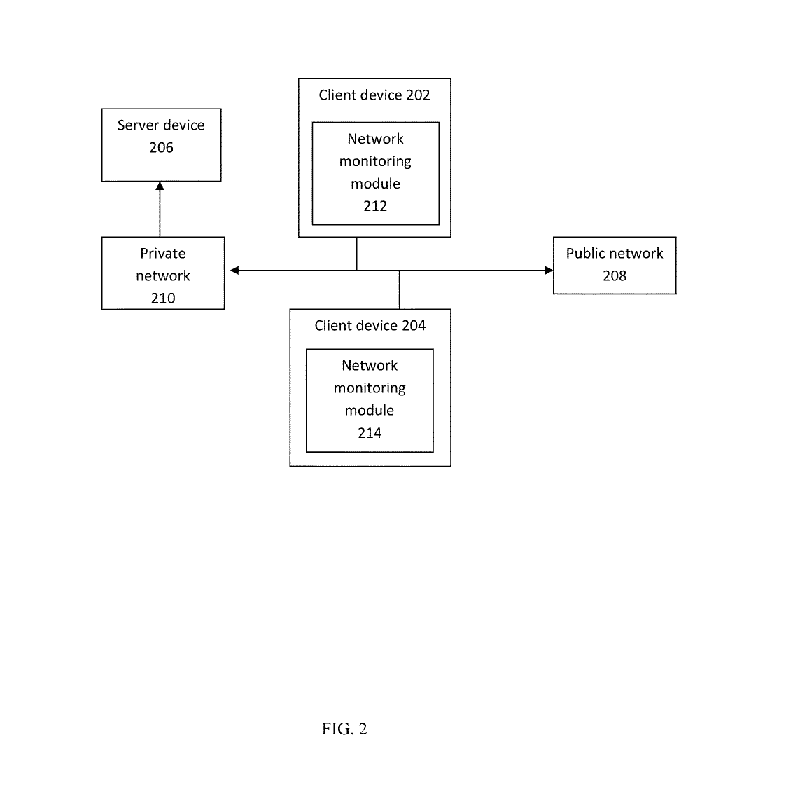

FIG. 1 depicts the client device connected to the server unit via the public network. However, it is to be noted that the client device may be connected to the server unit via a private network (as is shown in FIG. 2). The public networks include Intranet, LAN, WAN or such type of networks for communicating data or signals between two points.

The system further comprises a network monitoring module coupled to the client device. Although FIG. 2 shows the network monitoring module to be embedded within the client device, skilled artisans shall however appreciate that the network monitoring module can be a stand-alone device embedded within a processing unit. In such case, the network monitoring module is configured for identifying the client device using the IP address of the client device and is linked to one or more applications running on the client device.

The network monitoring module is in communication with inbound and outbound traffic of the client device. The network monitoring module is a passive probe coupled to the public network. In one embodiment, the network monitoring module is configured for monitoring the network connection based on an establishment of a transmission control protocol (TCP) connection. TCP protocol may be used by many applications for reliable non-real-time data transfer. The applications using TCP include Internet protocol (HTTP), FTP, SMTP, user datagram protocol (UDP) and Real Time Transport Protocol (RTP).

The Hyper Text Transfer Protocol (HTTP) is the default protocol used for web browsing. The HTTP protocol uses the reliable TCP (Transmission Control Protocol) as the underlying transport layer protocol. For every web site visited by the user of the client device through a browser, the browser sends an HTTP request to the web site's web server. This means that a TCP connection is first opened from the client device to a remote web server. Only upon successful establishment of a TCP connection, the client device sends the HTTP request to the web server through this TCP connection. Apart from HTTP, other common applications used by users of the client devices, like SMTP (Simple Message Transfer Protocol) for Email and FTP (File Transfer Protocol) for file transfer also use TCP as the underlying transport protocol.

TCP is a connection-oriented protocol and a logical connection has to be opened between the client device (TCP client) and the server unit (TCP server) prior to initiating application data transfer. TCP uses a 3-way handshake protocol for connection establishment. The TCP client starts the handshake by sending a TCP-SYN (synchronization) message to the remote TCP server. The remote server responds back with a TCP-SYN-ACK message to the TCP client. On receiving the TCP-SYN_ACK message, the TCP client responds by sending a TCP-ACK message back to the TCP server in order to complete the 3-way handshake and the logical TCP connection establishment process. Upon successful establishment of the connection, the client device and the server unit send application data (in this case the HTTP request and the corresponding HTTP reply in the form of web page contents).

TCP segments are carried inside IP (Internet Protocol) packets. Hence, if the client device receives a TCP-SYN_ACK message from a remote server in response to a TCP-SYN message sent by it, then it means that IP packets are able to be received by the client device from remote computers through the internet. This in turn means that the client device ISP's internet connectivity is up at that instant, as the IP packets enter and exit the client device through the ISP's connection.

In embodiments, the invention provides a technique to add additional intelligence at the client device to watch the TCP connection establishment process for each and every external TCP connection initiated by the client device and to use this information to maintain statistics about the availability of the internet connectivity at the client device.

Typical statistics would include the percentage of successful TCP connection establishments and also the percentage of failed TCP connection establishments, along with a timestamp (date & time) of each successful or failed attempt.

Alternatively, if there are storage space constraints at the client device, it could just maintain timestamps for the last successful and failed connections alone, along with the cumulative success and failure percentages. Typically, standard TCP/IP implementations provide hooks to an application program to register with it for protocol specific events. This way, application programs can receive information as to when a TCP-SYN is sent out of the client device and similarly when a reply TCP-SYN_ACK is received by the client device. Further, since commonly used application protocols by users of the client devices like HTTP, SMTP, FTP etc. use TCP as the underlying transport layer protocol, the availability of the ISP's connection is automatically monitored every time the user of the client device attempts to use these protocols (e.g. every time user accesses any web site, transfers a file or sends/receives emails etc.) without generating additional overhead traffic for this purpose.

Additionally, whenever the client device fails to receive back a TCP-SYN_ACK from a remote web server in response to a TCP-SYN, then it may be due to one of a failed internet connectivity at the client device (at that instant) and functional impairment of the web server.

In one embodiment, the client device is configured for selectively sending explicit probe packets upon detecting a failed TCP connection. For this purpose, the network monitoring module is configured for conducting a probe test. The probe test comprises sending an internet control message protocol, (ICMP) ECHO REQUEST (IP packets) to a gateway server. The gateway server is configured for interfacing the client device with the worldwide web server. The gateway server, upon receiving the ping, answers by sending a response packet within a predetermined time period. The network monitoring module is configured to record an indication of failure if no response is received within an allotted time.

In one embodiment, the invention provides a technique to passively learn the connectivity status of the ISP by watching incoming IP packets using the network monitoring module at the client device. In this particular embodiment, the network monitoring module may be firewall software configured for passive network monitoring of the real time network traffic at the client device. Typically, the client device may not run firewall software, because the firewall is typically run in the ISP's modem. However, in this embodiment, where a client device runs firewall software, it is possible to verify the ISP's connectivity based on incoming IP packets. Since, the firewall software watches the IP packets entering the client device, the arrival of an incoming IP packet to the client device from a public IP address indicates the presence of internet connectivity at the client device. Subsequent to receiving the IP packet, the client device may update its network monitoring statistics accordingly (for example, the network monitoring module may update the timestamp indicating the time of recent receipt of the incoming IP packet).

In one embodiment, the network monitoring module may comprise a hardware component comprising one of an optical splitter, passive serial line connector, interface mirroring device, system supported by a router or switch, passive interfaces on a broadcast LAN or such monitoring device.

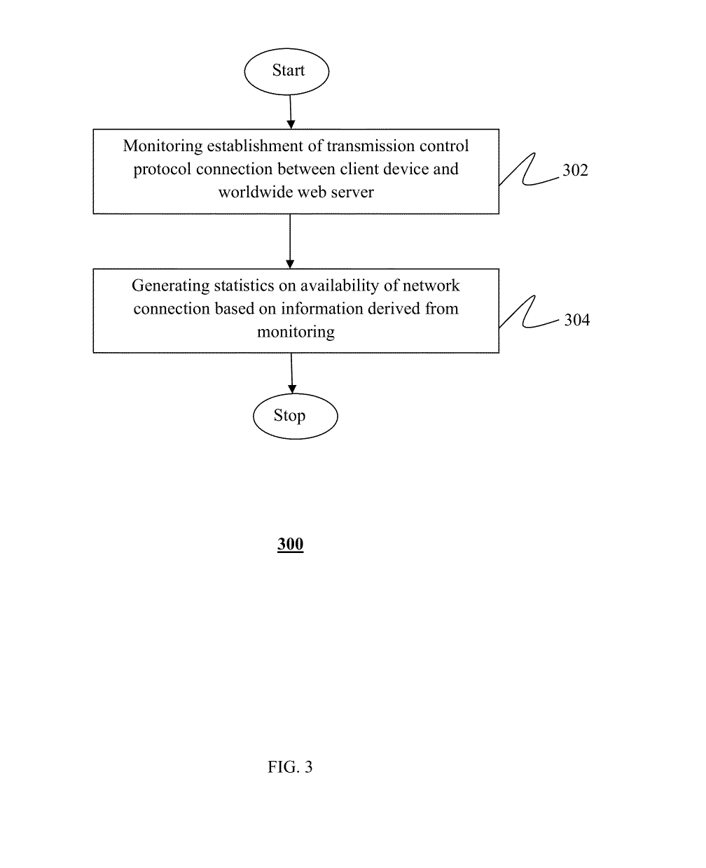

In another embodiment, as shown in FIG. 3, a method of monitoring network connection is provided. The method comprises steps of monitoring establishment of a transmission control protocol connection between a client device and a worldwide web server and generating networking monitoring statistics on availability of network connection based on the information derived from the monitoring.

Further, the method of monitoring establishment comprises monitoring a successful establishment of a transmission control protocol connection between the client device and the worldwide web server, updating the statistics on availability of network connection following a successful establishment of the connection and recording a time stamp indicating the time of successful establishment of the connection.

Alternatively, the method of monitoring establishment comprises monitoring a failed establishment of a transmission control protocol connection between the client device and the worldwide web server, updating the statistics on availability of network connection following a failed establishment of the connection and recording a time stamp indicating the time of failed establishment of the connection.

In cases where the network monitoring module monitors the establishment of failed network connection, the method further comprises conducting a probe test. The probe test comprises transmitting a test packet to the gateway server, updating the statistics on availability of network connection following a successful establishment of the connection upon receiving a response from the gateway sever and recording a time stamp indicating the time of successful establishment of the connection.

Alternatively, the method of conducting the probe test comprises transmitting a test packet to the gateway server, updating the statistics on availability of network connection following a failed establishment of the connection upon not receiving a response from the gateway sever within a predetermined time period and recording a time stamp indicating the time of failed establishment of the connection. The method further comprises generating an alert at the client device. The alert may be one of audio, visual and tactile.

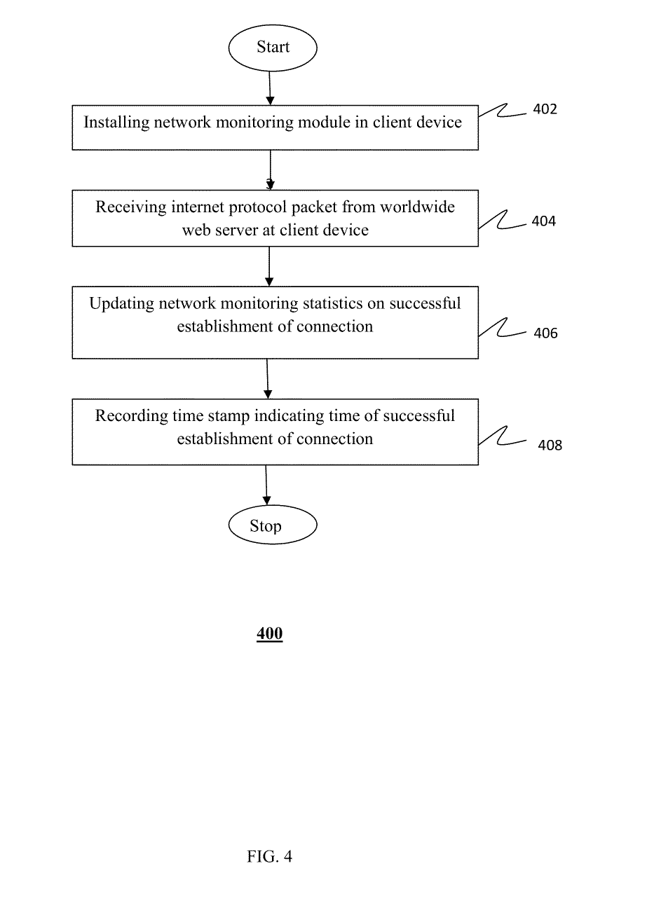

In yet another embodiment, as shown in FIG. 4, another method of monitoring network connection is provided. The method comprises steps of installing a network monitoring module in a client device, the network monitoring module being configured for monitoring an inflow of one or more internet protocol (IP) packets, receiving an internet protocol packet from a worldwide web server, updating network monitoring statistics following a successful establishment of the connection in response to receiving the IP packet and recording a time stamp indicating the time of successful establishment of the connection.

The network monitoring module stores the network monitoring statistics along with time stamps in a memory module, coupled to the network monitoring module, without further processing the data. Since minimal processing is performed at this stage, this task can be performed in real time.

The method further comprises generating a dynamic report based on network monitoring statistics and the time stamps and sending the report to the server unit based on a trigger. The trigger may be time based, change based and request based. In the time based trigger, the dynamic report is sent subsequent to the completion of a predetermined (set by user) time period. In the change based trigger, the dynamic report is sent upon monitoring significant changes in the network monitoring statistics. In the request based trigger, the dynamic report is sent consequent to receiving a request from the server unit. This saves lot of storage space on the server unit as the network monitoring statistics are maintained and stored in a distributed manner within the network of the client device.

Embodiments of the present invention may be embodied as, among other things: a method, system or computer-program product. Accordingly, the embodiments may take the form of a hardware embodiment, a software embodiment, or an embodiment combining software and hardware. In one embodiment, the present invention takes the form of a computer-program product that includes computer-useable instructions embodied on one or more non-transitory computer-readable media.

Accordingly, in one embodiment, a computer program product comprising instructions to be executed by a processor so as to result in the monitoring of network connection is provided. The instructions comprise a routine for monitoring establishment of a transmission control protocol connection between a client device and a worldwide web server and a routine for generating network monitoring statistics on availability of network connection based on information derived from the monitoring.

Further, computer-readable media includes both volatile and nonvolatile media and removable and non-removable media, and contemplates media readable by a database, a switch, and various other network devices. By way of example, and not limitation, computer-readable media comprise media implemented in any method or technology for storing information. Examples of stored information include computer-useable instructions, data structures, program modules, and other data representations. Media examples include, but are not limited to, information-delivery media, RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data momentarily, temporarily, or permanently.

The invention provides systems and methods to monitor the availability of ISP connection to a user of a client device, based on the actual internet usage of the user, without generating additional overhead traffic specifically for this purpose.

In one embodiment, the invention provides a technique for passively monitoring external TCP connection establishments so as to assess the availability of network connection. Some of the advantages of this invention include reduced internet billing costs for end users, reduction in processing power, storage requirements, network bandwidth and network traffic at the server unit and ISP ends, availability of sufficient data for monitoring the quality of ISP's connectivity and provision for generating immediate alerts to end users upon sensing a problem in ISP connection.

Another advantage is the minimal processing overhead at the client device, as the mechanism watches only the TCP connection establishment process (few packets) and not the data transfer process (large number of packets). Yet another advantage of the invention is that it is not only applicable to end users of the client device but also to any computer(s) accessing the internet through an ISP, including enterprise devices. Hence, the applicability of the invention is not limited to domestic (home) users and extends to enterprise and corporate users, enabling them to dynamically monitor the availability and quality of the internet connection provided by their ISP.

This written description uses examples to describe the subject matter herein, including the best mode, and also to enable any person skilled in the art to make and use the subject matter. The patentable scope of the subject matter is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system for monitoring network connection, the system comprising:
at least one client device configured for providing a user access to a public network; and
a network monitoring module coupled to the client device, the network monitoring module configured for monitoring the network connection based on an establishment of a transmission control protocol connection between the client device and the public network.

2. The system of claim 1, wherein the network monitoring module is embedded within the client device.

3. The system of claim 1, wherein the public network comprises one or more public network protocols.

4. The system of claim 1, wherein the public network is one of a wired and a wireless network.

5. The system of claim 1, wherein the private network comprises one or more private network protocols.

6. The system of claim 1, further comprising a server unit coupled to each of the client devices via a private network, the server unit configured for managing one or more user requests from each of the client devices.

7. The system of claim 6, wherein the private network is one of a wired and a wireless network.

8. A method of monitoring network connection, the method comprising:
monitoring establishment of a transmission control protocol connection between a client device and a worldwide web server; and
generating statistics on availability of network connection based on the information derived from monitoring.

9. The method of claim 8, wherein monitoring establishment of connection comprises:
monitoring a successful establishment of a transmission control protocol connection between the client device and the worldwide web server;
updating the statistics on availability of network connection following a successful establishment of the connection; and
recording a time stamp indicating the time of successful establishment of the connection.

10. The method of claim 8, wherein monitoring establishment of connection comprises:
monitoring a failed establishment of a transmission control protocol connection between the client device and the worldwide web server;
updating the statistics on availability of network connection following a failed establishment of the connection; and
recording a time stamp indicating the time of failed establishment of the connection.

11. The method of claim 10, further comprising conducting a probe test, the probe test comprising:
transmitting a test packet to a gateway server, the gateway server configured for interfacing the client device with the worldwide web server;
updating the statistics on availability of network connection following a successful establishment of the connection upon receiving a response from the gateway sever; and
recording a time stamp indicating the time of successful establishment of the connection following the receipt of response.

12. The method of claim 10, further comprising conducting a probe test, the probe test comprising:
transmitting a test packet to a gateway server, the gateway server configured for interfacing the client device with the worldwide web server;
updating the statistics on availability of network connection following a failed establishment of the connection upon not receiving a response from the gateway sever within a predetermined time period; and
recording a time stamp indicating the time of failed establishment of the connection.

13. The method of claim 12, further comprising generating an alert to be displayed on the client device.

14. A method of monitoring network connection, the method comprising:
installing a network monitoring module in a client device, the network monitoring module configured for monitoring an inflow of one or more internet protocol packets;
receiving an internet protocol packet from a worldwide web server;
updating network monitoring statistics following a successful establishment of the connection upon receiving the internet packet; and
recording a time stamp indicating the time of successful establishment of the connection.

15. The method of claim 14, further comprising generating a dynamic report based on network monitoring statistics and the time stamp; and
sending the report to the server unit based on a trigger, the trigger being time based, change based and request based.
